(19) United States
(12) Patent Application Publication
(10) Pub. No.: US 2014/0132766 A1
(43) Pub. Date: May 15, 2014

(54) Real time videographic transmission notification, viewing and memorialization system to facilitate protection and remuneration of individuals

(71) Applicant: John Chester Stuart, Phoenix, AZ (US)

(72) Inventor: John Chester Stuart, Phoenix, AZ (US)

(21) Appl. No.: 13/987,901

(22) Filed: Sep. 13, 2013

Related U.S. Application Data
(60) Provisional application No. 61/852,041, filed on Mar. 14, 2013.
(60) Provisional application No. 61/743,943, filed on Sep. 14, 2012.

(51) Int. Cl. G08B 13/196

(52) U.S. Cl. CPC G08B 13/196
USPC 348/143

(57) ABSTRACT

A system a first individual to witness and record an event occurring to a second individual at a locate remote from the first individual. The first and second individual function as members of the press and have a pre-existing agreement making them co-videographers.

This application claims priority based on U.S. Provisional Patent Application Ser. No. 61,852,041 filed Mar. 14, 2013 and U.S. Provisional Patent Application Ser. No. 61/743,943 filed Sep. 14, 2012.

This invention relates to smart phones and other electronic devices for recording and transmitting audio and video signals.

The use of digital and analog devices to record audio and video signals is well known.

Those of skill in the art have for many years endeavored to provide improved equipment and procedures to record and transmit audio visual signals. Accordingly, it is desirable to provide such improved equipment and procedures.

Therefore, it is a principal object of the invention to provide an improved system to communicate audio visual signals between smart phones and other electronic devices.

Another object of the invention is to protect an individual from injury to his person or his property when the individual is utilizing an iPhone or other electronic device to record an event,

A further object of the invention is to facilitate remunerating an individual for any damage to his person or his property, including, but not limited to, any damage resulting from the tortious interference with a contractual relationship or business opportunity of the individual and of any others associated with the individual.

Still another object of the invention is to deter others from unlawfully injuring others or the property of others.

These and other, further and more specific objects and advantages of the invention will be apparent to those skilled in the art from the following detailed description thereof, taken in conjunction with the drawings, in which:

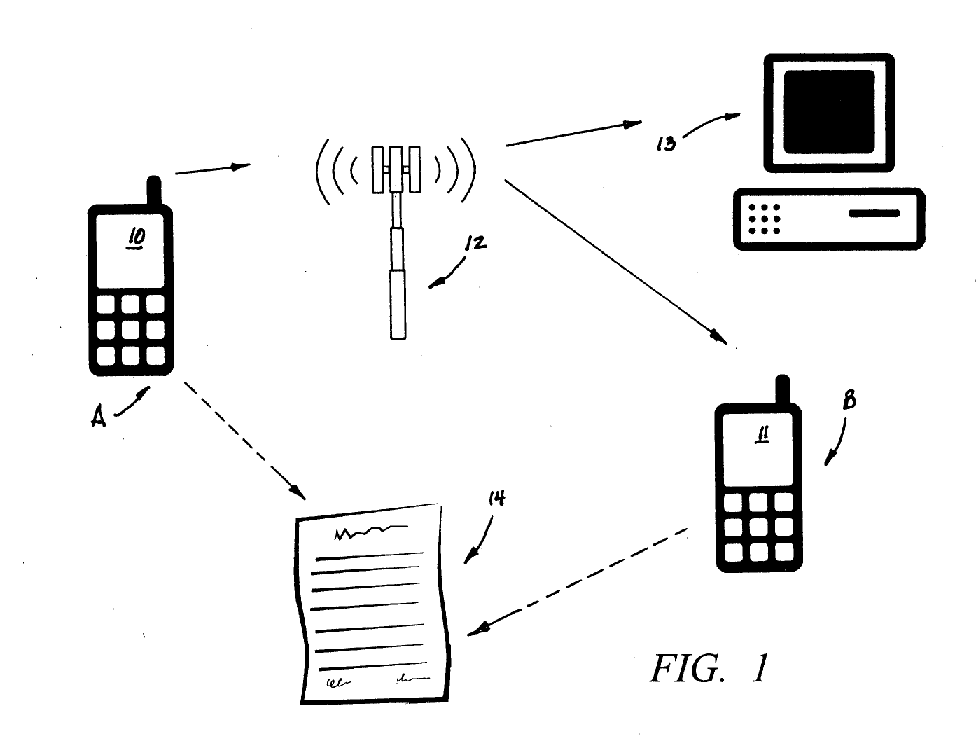

FIG. 1 is a diagram illustrating a system constructed in accordance with the invention.

As used herein, the press comprises individuals and/or organizations that gather and publish news or other information. The press includes, without limitation, authors, columnists, commentators, correspondents, editors, interviewers, journalistic writers, journalists, literary publications, media, members of the media, members of the press, news business, news gatherers, newsmen, newspaper world, newspaperman, newspapers, newswriters, publicists, publishers, and reporters. The press also includes the news media.

The news media are those elements of the mass media that focus on delivering news to the general public or a target public. These include print media (newspapers, news magazines), broadcast news (radio and television), and more recently the Internet (online newspapers, news blogs, etc.).

Freedom of the press, including the news media, is the right, guaranteed by the First Amendment to the U.S. Constitution, to gather, publish, and distribute information and ideas without government restriction. This right encompasses freedom from prior restraints on publication and freedom from censorship.

Briefly, in accordance with the invention, provided is a real time videographic transmission, notification, viewing and memorialization system to facilitate protection and remuneration of individuals. The system includes at least first and second portable handheld electronic devices. Each electronic device includes a camera capable of producing a video recording of an event; a transmission--receiving system to transmit the video recording to the other of the electronic devices and to receive a video recording made by the other of the electronic devices; a system to alert the operator of one of the electronic devices when a video recording being made real time is being sent real time to the one of the electronic devices from the other of the electronic devices; a display system so that the operator of each of the devices can view in real time a-video recording received from the other one of the devices; a system to inform a person being filmed with the first or second electronic device that the videographer utilizing the first or second electronic device is a member of the press; and, a contractual agreement between the operators of the first and second electronic devices that each is a co-videographer for the other.

In another embodiment of the invention, provided is a real time videographic transmission, notification, viewing and memorialization system to facilitate protection and remuneration of individuals. The system includes at least first and second portable handheld electronic devices. Each device includes a camera capable of producing a video recording of an event; a transmission--receiving system to transmit the video recording to the other of the electronic devices and to receive a video recording made by the other of the electronic devices; a system to alert the operator of one of the electronic devices when a video recording being made real time is being sent to the one of said electronic devices from the other of the electronic devices; a display system so that the operator of each of the devices can view in real time a video recording received from the other one of the devices. The videographic system also includes a system to inform a person being filmed with the first or second electronic device that the videographer utilizing the first or second electronic device is a member of the press; a contractual agreement between the operators of the first and second electronic devices that each is a co-videographer for the other; a system using location identification (including without limitation, Global Position Satellites (“GPS”) to record and inform co-videographers of the location of the co-videographer initializing the video; a system to inform each videographer of the other's intent to travel to the location being videographed. The videographic system preferably also is compliant with local, state and/or federal rules of evidence in connection with any or all types of prospective litigation by the videographer(s). The videographic system can also include a system to supply any videos or recordings “live” to other types of media and organizations as a means to immediately inform the general public and any other desired parties.

In accordance with one embodiment of the invention, the first part of the new system comprises at least first and second iPhones or other electronic devices. Each iPhone or other electronic device:

(1) has the capacity to communicate with and send audio visual or other data to the other iPhone,

(2) has the ability to download to the iPhone an “app”, or software program, which facilitates the communication of the iPhones with each other, and, in particular, facilitates the real time transmission (via the Internet, cell phone towers, or any other desired means) of a video recording or sound recording from one iPhone to the other iPhone,

(3) has the capacity to make a video and sound recording of a subject selected from a group consisting of persons, places, objects, and events,

(4) has the capacity to store in its memory a video and sound recording of a selected subject,

(5) has the capacity to transmit, in real time, to the other iPhone the video or sound recording of selected subject which is being recorded by the videographer,

(6) has the capacity to display a video or sound recording being recorded and transmitted real time by the other iPhone, and

(7) has the capacity to activate an alarm on the iPhone (say the first iPhone) when the other iPhone (say the second iPhone) is recording, in real time, a selected subject, which alarm functions to alert the owner of the first iPhone that the second iPhone is recording a video in real time and that the owner of the first iPhone can elect to watch on his iPhone the video and/or sound recording as it is being recorded real time by the owner or operator of the second iPhone.

The iPhones or other handheld portable devices each include microprocessors which are constructed and programmed to perform or assist in performing any desired ones of the functions described herein. The handheld portable devices also include transmitter--receivers and other apparatus necessary to perform any desired ones of the functions described herein.

A second part of the new system is referred to above and comprises cell towers, the Internet, or other apparatus or systems utilized to send or record communications between the first and second iPhones.

A third part of the new system can comprise an individual or company or other organization which facilitates and manages transmissions between the first and second iPhones or between other selected electronic devices.

A fourth part of the new system can comprise a server 13 or other electronic device which, separately from the first and second iPhone, receives transmissions from the first and second iPhones and stores video recordings or sound recordings produced by the iPhones.

A fifth component of the new system can comprise a contractual relationship between the owners/operators of the first and second iPhones in which (1) each is a videographer for the other, and (2) when the owner of the first iPhone is making a video/sound recording with the first iPhone and the owner of the second iPhone is viewing said recording real time as it is made, the owners of the first and second iPhones are co-videographers.

A sixth component of the new system can comprise having a videographer who is using his iPhone or other electronic device to make a video recording or sound recording notify the person(s) being filmed that the videographer is a member of the press by verbally stating the same or by means of a readily seen card or identification on the person or equipment of the videographer that informs the person(s) being filmed that the videographer is a member of the press.

In a further embodiment of the invention, the owners of the first and second iPhones each enter into a contract 14 that each is a videographer for the other and that it is anticipated that videographs made by other will generate income or other remuneration, or will serve some other legitimate business purpose.

In still another embodiment of the invention, the owners of the first and second iPhones enter into a contract that each is a videographer for the other and, further agree to inscribe identification on each of their iPhones (such as the word “PRESS” or “CO-VIDEOGRAPHER”) or other equipment so that 3^{rd} party individuals seeing the mark will arguably understand that each individual is a member of the press and likely is a co- videographer.

In another embodiment of the invention, the owners of the first and second iPhones each agree to notify (verbally, with a business card, or with other means) a third party being recorded with the first or second iPhone that he (the owner or operator of the iPhone being used to create a video or sound recording) has co-videographers who works with him to achieve a profit or to achieve some other legitimate business purpose. For example, if a videographer has a card on which “PRESS” is printed in large letters, the word “CO-VIDEOGRAPHER” can also be printed on the card in a readily viewed font.

In still another embodiment of the invention, a video being made real time by the operator of the first iPhone is sent to and viewed real time by over one hundred co-videographers, or the minimum number of co-videographers necessary to institute a class action lawsuit.

In yet still another embodiment of the invention, when the operator of a first iPhone is making and transmitting a video recording and/or sound recording, the recording is transmitted only to the iPhones of videographers who are in a selected restricted localized geographical area; i.e., if a videographer is filming an event in Phoenix, Ariz., the video will be transmitted only to the iPhones of co-videographers located in the city of Phoenix, in the state of Arizona, or in another selected geographical area(s).

In still another embodiment of the invention, the videographic system of the invention permits advertising to be played before, during or after any video that is viewed by an party.

In still another embodiment of the invention, I provide a system to control what advertising is played or attached in any way to any recorded or live stream videos.

In still another embodiment of the invention, I provide a system to acquire financial and/or other remuneration for advertising relevant to a video(s) recorded using the videographic system of the invention.

The videographic system of the invention is preferably made compliant with local, state and federal rules of evidence so that an audiovisual recording made with the system can be introduced as evidence in litigation. For example, in some state or areas, the videographer may be required to verbally or in writing inform the person(s) being filmed that such a film is being made. Such a notification by the videographer may be required before filming begins. Or, the consent of the person being filmed may have to be secured.

The following example is provided by way of illustration, and not limitation, of the invention.

### EXAMPLE

Individuals A and B (the videographers) each own an iPhone or other handheld portable electronic device. For purposes of this example, the electronic device owned by individual A is indicated in FIG. 1 by reference character A and the electronic device owned by individual B is indicated by reference character B. Each electronic device A or B:

(1) has the capacity to communicate with and send data to the other electronic device.

(2) has the ability to download to the electronic device an “app”, or software program, which facilitates the communication of the electronic devices with each other, and, in particular, facilitates the real time transmission (via the Internet, cell phone towers, or any other desired means) of a video recording or sound recording from one electronic device to the other electronic device.

(3) has the capacity to make a video and sound recording of a subject selected from a group consisting of persons, places, objects, and events,

(4) has the capacity to store in its memory a video and sound recording of a selected subject,

(5) has the capacity to transmit, in real time, to the other electronic device the video or sound recording of a selected subject which is being recorded by the videographer,

(6) has the capacity to display 10, 11 a video or sound recording being recorded and transmitted real time by the other electronic device, and

(7) has the capacity to activate an alarm on the electronic device (say the electronic device A) when the other electronic device (say electronic device B) is recording, in real time, a selected subject, which alarm functions to alert the owner of electronic device A that electronic device B is recording a video in real time and that the owner of electronic device A can elect to watch 10 on electronic device A the video and/or sound recording as it is being recorded real time by the owner or operator of electronic device B.

Individuals A and B enter a contractual relationship. The contract 14 between individuals A and B states that (1) each is a videographer for the other, (2) when the owner of electronic device A is making a video/sound recording with electronic device A, and the owner of electronic device B is viewing 11 the recording real time as it is made, individuals A and B are co-videographers, (3) when either individual A or individual B is using electronic device A or B, respectively, the videographer who is using his electronic device to make a video recording or sound recording shall notify the person(s) being filmed that the videographer is a member of the press by verbally stating the same or by means of a readily seen card or identification on the person or equipment of the videographer that informs the person(s) being filmed that the videographer is a member of the press, (4) it is anticipated that videographs made by individuals A and B will generate income or other remuneration, or will serve some other legitimate business purpose, (5) individuals A and B each agree to inscribe identification on his electronic device (such as the word “PRESS” or “CO-VIDEOGRAPHER”) or other equipment so that 3^{rd} party individuals seeing the mark will arguably understand that each individual is a member of the press and likely is a co-videographer, (6) individuals A and B each agree to notify (verbally, with a business card, or with other means) a third party being recorded with electronic device A or B that he (the owner or operator of the electronic device being used to create a video or sound recording) has co-videographers who works with him to achieve a profit or to achieve some other legitimate business purpose. For example, if a videographer has a card on which “PRESS” is printed in large letters, the word “CO-VIDEOGRAPHER” can also be printed on the card in a readily viewed font.

Individual A becomes involved in a face-to-face disagreement with individual C. Individual A begins recording the disagreement and notifies individual C that he, individual A, is a member of the press and has a co-videographer. The word “PRESS” is inscribed in large bold letters (and are plainly visible to individual C) on electronic device A and on “a shoulder carry bag worn by individual A, as is the word “CO-VIDEOGRAPHER.” As soon as individual A begins recording the disagreement, a signal is transmitted to electronic device B, and individual B begins watching 11, and therefore witnessing, the disagreement being filmed by individual A. Individual B is at a location remote from individual A. The location of individual A appears on electronic device B. The location is determined by a GPS system in device A and transmitted by device A to device B. Electronic device A and electronic device B each automatically record the audiovisual record of the disagreement between individuals A and C. The transmission between device A and B are made using a cellular telephone network 12, although any other network or system can be utilized.

During the disagreement between individuals A and C, individual C strikes individual A. Individual B dials 911 and provides the location of individual A.

Individual A file a civil lawsuit against individual C to recover damages for the injuries caused to individual A by individual C. The audiovisual record of the disagreement between individuals A and C is introduced as and accepted into evidence. The audiovisual record is from device B because during the disagreement between individuals A and C, individual C eventually damaged electronic device A.

Having described my invention in such terms as to enable those of skill in the art to understand and practice it, I claim:

1. A real time videographic transmission, notification, viewing and memorialization system to facilitate protection and remuneration of individuals, said system including
(a) at least first and second portable handheld electronic devices each including
(i) a camera capable of producing a video recording of an event,
(ii) a transmission--receiving system to transmit said video recording to the other of said electronic devices and to receive a video recording made by the other of said electronic devices,
(iii) a system to alert the operator of one of said electronic devices when a video recording being made real time is being sent real time to said one of said electronic devices from the other of said electronic devices,
(iv) a display system so that the operator of each of said devices can view in real time a video recording received from the other one of said devices;
(b) a system to inform a person being filmed with the first or second electronic device that the videographer utilizing the first or second electronic device is a member of the press; and,
(c) a contractual agreement between the operators of said first and second electronic devices that each is a co-videographer for the other.

2. A real time videographic transmission, notification, viewing and memorialization system to facilitate protection and remuneration of individuals, said system including
(a) at least first and second portable handheld electronic devices each including
(i) a camera capable of producing a video recording of an event,
(ii) a transmission--receiving system to transmit said video recording to the other of said electronic devices and to receive a video recording made by the other of said electronic devices,
(iii) a system to alert the operator of one of said electronic devices when a video recording being made real time is being sent to said one of said electronic devices from the other of said electronic devices,
(iv) a display system so that the operator of each of said devices can view in real time a video recording received from the other one of said devices;
(b) a system to inform a person being filmed with the first or second electronic device that the videographer utilizing the first or second electronic device is a member of the press;
(c) a contractual agreement between the operators of said first and second electronic devices that each is a co-videographer for the other;
(d) a system using location identification to record and inform co-vieographers of the location of the co-videographer initializing the video;
(e) a system to inform each videographer of their intent to travel to the location being videographed;
(f) a system compliant with local, state and/or federal rules of evidence relative to litigation involving an audiovisual recording made by said electronic devices; and,
(g) a system to supply all such videos and/or recordings “live” to any and/or all other types of media and/or organizations as a means to immediately inform the general public and other interested and/or uninterested parties.
